(19) United States
(12) Patent Application Publication
(10) Pub. No.: US 2026/0349705 A1
(43) Pub. Date: Nov. 5, 2026

(54) LAYERED API-DRIVEN PATCH MANAGEMENT SYSTEM WITH VENDOR-INDEPENDENT COMPONENT ARCHITECTURE

(71) Applicant: Senserva, LLC, Saint Paul, MN (US)

(72) Inventor: MARK SHAVLIK, White Bear Lake, MN (US)

(21) Appl. No.: 19/663,652

(22) Filed: Apr. 30, 2026

Related U.S. Application Data
(60) Provisional application No. 63/797,399, filed on Apr. 30, 2025.

(51) Int. Cl. G06F 8/65

(52) U.S. Cl. CPC G06F 8/65

(57) ABSTRACT

A layered, vendor-independent patch management platform for managing software updates across heterogeneous computing environments is disclosed. The system includes multiple functional layers configured to perform endpoint communication, patch detection, patch deployment, and patch information management using standardized interfaces. A repository intelligence component aggregates patch data from multiple external sources and normalizes the data into a unified schema. An installation intelligence component generates installation instructions and validates the instructions prior to deployment. An orchestration component coordinates patch management operations, including prioritization, sequencing, and verification. The system further implements a feedback mechanism that captures deployment outcomes and updates the repository to improve subsequent operations.

### CROSS-REFERENCE TO RELATED APPLICATIONS

The present application claims priority from U.S. Provisional Patent Application No. 63/797,399, filed on Apr. 30, 2025, the disclosure of which is hereby incorporated by reference in its entirety.

### BACKGROUND

Current patch management solutions suffer from vendor lock-in issues and incomplete coverage, forcing organizations to either accept coverage gaps in critical patches or implement multiple disparate systems. Traditional patch management approaches require all-or-nothing adoption of vendor solutions, leading to cost inefficiencies and complex migration challenges when organizations need to switch providers or integrate multiple systems.

Existing patch management systems are further constrained by non-standardized APIs and inconsistent data formats across different vendors. These technical limitations create substantial integration challenges, particularly when handling multiple agent types or implementing cross-platform compatibility. Current solutions struggle to efficiently manage the complexity of modern computing environments, where a single machine may require management of thousands of applications and potential updates. The lack of standardization in patch metadata and deployment protocols across vendors creates additional technical barriers, especially in environments requiring complex patch installations or operating across clustered systems.

Current technical architectures fail to provide a comprehensive solution that enables vendor independence without sacrificing performance or security. These limitations result in extended vulnerability windows, increased security risks, and higher operational costs for organizations managing patch deployment across their infrastructure.

### SUMMARY

In general, a layered API-driven patch management system is provided that enables vendor-independent component architecture through a layered technical framework. The system implements standardized APIs and data translation capabilities to overcome traditional vendor lock-in limitations while maintaining comprehensive patch coverage across diverse computing environments.

In a first aspect, layered patch management system includes a processor and a memory configured to store instructions. When these instructions are executed by the processor, they enable the processor to perform several distinct functions. First, an agent management layer is implemented, which provides a set of standardized management APIs designed to handle endpoint communication across various types of agents. Next, a patch scan layer is utilized, which employs one or more unified APIs to detect missing patches through the use of multiple scanning technologies. The system also incorporates a missing patch remediation layer, which supports multiple patch management APIs to facilitate the deployment and installation of patches across different technologies. Finally, a patch information independent layer is implemented, offering a range of universal APIs that standardize patch metadata from multiple patch software suppliers.

In a second aspect, a method for vendor-independent patch management involves implementing standardized APIs across multiple software layers, including an agent management layer, a patch scanning layer, a patch remediation layer, and a patch information management layer. This approach enables mixed-vendor deployment by allowing the integration of components from various patch suppliers within each of these software layers. The method also includes translating patch data between different supplier formats using a standardized schema, ensuring compatibility and consistency. Additionally, it involves maintaining a unified patch catalog that consolidates metadata from multiple software patch suppliers.

In a third aspect, a non-transitory computer-readable medium stores instructions that, when executed by a processor, cause the processor to carry out a series of operations. These operations include implementing a four-layer patch management architecture that utilizes standardized APIs. The architecture supports seamless component-level vendor migration without interrupting overall system functionality. It also manages software updates across numerous machines within an enterprise by employing various categorization and prioritization mechanisms. Additionally, the system maintains comprehensive audit trails of all patch-related activities across each layer of the patch management architecture.

In still further examples, a computer-implemented patch management system is disclosed that provides a layered, vendor-independent architecture for managing software updates across heterogeneous computing environments. The system includes multiple functional layers configured to perform endpoint communication, patch detection, patch deployment, and patch information management using standardized interfaces. A repository intelligence component aggregates patch data from multiple external sources and normalizes the data into a unified schema. An installation intelligence component generates installation instructions and validates the instructions prior to deployment. An orchestration component coordinates patch management operations, including prioritization, sequencing, and verification. The system further implements a feedback mechanism that captures deployment outcomes and updates the repository to improve subsequent operations. In some embodiments, detection rules used to identify missing patches are reused to verify successful installation. The architecture supports distributed deployment, interoperability with multiple vendors, and continuous improvement of patch management processes.

In a particular further aspect, a computer-implemented patch management system is provided. The system includes a processor and a memory storing instructions that, when executed, cause the processor to implement a plurality of functional layers including an agent management layer, a patch scan layer, a remediation layer, and a patch information layer. The patch information layer maintains a unified patch catalog using a vendor-independent schema. The system further includes a repository intelligence layer configured to ingest patch data from a plurality of heterogeneous sources and normalize the patch data into the vendor-independent schema, and an orchestration layer configured to coordinate patch management operations. The system enables vendor-independent patch management across multiple patch vendors and computing environments.

In another aspect, a computer-implemented method for patch management is provided. The method includes aggregating patch data from a plurality of heterogeneous sources, normalizing the patch data into a unified schema, and scanning computing systems to detect missing patches. The method further includes generating installation instructions for the missing patches, validating the installation instructions, deploying the patches to the computing systems, and verifying successful installation of the patches. The method also includes updating a patch repository based on results of deployment and verification, wherein the method operates as a closed-loop process that improves subsequent patch management operations.

In another aspect, a system for maintaining a patch repository is provided. The system includes a plurality of source adapters configured to retrieve patch data from external data sources, and a monitoring subsystem configured to detect failures in the source adapters, including both explicit failures and silent failures in which expected data is not returned. The system further includes a recovery subsystem configured, in response to detecting a failure, to retrieve patch data directly from an external data source and update the patch repository, and to modify at least one of the source adapters to correct the failure. The retrieval and modification operations are performed without interrupting updates to the patch repository.

In another aspect, a computer-implemented system for orchestrating patch management operations is provided. The system includes a plurality of software agents including a triage agent configured to prioritize patches, a conflict detection agent configured to identify incompatibilities among patches, a sequencing agent configured to determine an order of patch installation, and a verification agent configured to evaluate installation results. The system further includes a shared data structure configured to store outputs generated by the agents and a processing pipeline configured to exchange outputs among the agents. The agents cooperatively generate a patch deployment plan based on characteristics of patches and target computing systems.

In another aspect, a non-transitory computer-readable medium is provided. The medium stores instructions that, when executed by a processor, cause the processor to generate installation instructions for software patches, execute the installation instructions on a computing system, verify installation success, and update a repository of patch knowledge based on the results. Subsequent installation instructions are generated based at least in part on the updated repository.

### BRIEF DESCRIPTION OF THE DRAWINGS

FIG. 1 is a schematic illustration of a layered patch management architecture according to aspects of the present disclosure.

FIG. 2 is a detailed diagram of the operations of the various layers of the layered patch management architecture of FIG. 1.

FIG. 3 is a schematic diagram of a Patch Data Translator component integration with the layered patch management architecture described herein.

FIG. 4 is a further schematic diagram illustrating use of the Patch Data Translator component in conjunction with a plurality of patch suppliers.

FIG. 5 illustrates an example computing system with which aspects of the present disclosure may be implemented.

FIG. 6 is a schematic diagram illustrating an expanded layered patch management architecture including an agent management layer, a patch information layer, a remediation layer, an installation intelligence layer, an artificial intelligence orchestration layer, and a repository intelligence layer, and further illustrating interactions with external patch sources and user interfaces.

FIG. 7 is a flow diagram illustrating a self-healing patch repository process including detection of failures in patch data ingestion and execution of parallel recovery operations comprising (i) retrieval of patch data from external sources and (ii) modification of source adapters, followed by repository update and monitoring.

FIG. 8 is a diagram illustrating a multi-source patch data aggregation pipeline including ingestion of patch data from a plurality of heterogeneous sources, normalization into a unified schema, enrichment and correlation of patch data, and distribution of processed data to downstream systems.

FIG. 9 is a flow diagram illustrating generation and execution of installation instructions based on patch metadata, including inference of installation parameters, generation of a normalized installation representation, selection of platform-specific strategies, execution of installation commands, and updating of a knowledge repository.

FIG. 10 is a flow diagram illustrating validation of installation instructions using an isolated execution environment, including preparation of a test environment, execution of installation instructions, evaluation of verification rules, and iterative correction of installation instructions based on validation results.

FIG. 11 is a flow diagram illustrating an end-to-end patch management lifecycle including patch discovery, normalization of patch data, scanning of computing systems, planning and prioritization, generation and validation of installation instructions, deployment of patches, verification of installation, and updating of a repository based on deployment outcomes.

FIG. 12 is a diagram illustrating a multi-agent orchestration process including a plurality of software agents configured to perform prioritization, conflict detection, sequencing, verification, and reporting, and further illustrating communication among the agents through shared data structures and processing pipelines.

FIG. 13 is a flow diagram illustrating a knowledge feedback process including collection of deployment data, generation of proposed knowledge updates, validation of the updates, optional human review, and incorporation of validated updates into a repository for subsequent use.

FIG. 14 is a schematic diagram illustrating translation of patch data from a plurality of vendor-specific formats into a unified schema, enrichment and correlation of the data, and conversion of the data into one or more output formats for use by downstream systems.

FIG. 15 is a schematic diagram illustrating a distributed patch management system architecture including a central control plane, processing infrastructure, data storage, distribution nodes, endpoint agents, and integration with external systems.

FIG. 16 is a flow diagram illustrating use of a common set of rules for both detection of missing patches and verification of successful installation of patches, wherein the rules are applied before and after installation to determine system state.

### DETAILED DESCRIPTION

As briefly described above, the present disclosure relates to a layered API-driven patch management system that enables vendor-independent component architecture through a layered technical framework. The system implements standardized APIs and data translation capabilities to overcome traditional vendor lock-in limitations while maintaining comprehensive patch coverage across diverse computing environments.

In some example implementations, the system includes a plurality of distinct technical layers, including an Agent Management Layer for standardized endpoint communication and agent handling, a Patch Scan Layer for unified missing patch identification, a Missing Patch Remediation Layer for standardized deployment and installation, and a Patch Information Independent Layer for comprehensive patch metadata management. Additionally, a Patch Data Translator enables conversion between vendor/supplier formats through standardized schema implementation and handles variations in naming conventions using XML/JSON formatting.

In example implementations, a Patch Scan Layer operates above an Agent Management Layer, implementing multiple scanning technologies through a unified API interface. This layer identifies missing patches and installed applications across the managed environment, standardizing the scan results format regardless of the underlying scanning technology used. The layer's architecture enables parallel operation of multiple scanning technologies, improving coverage while maintaining consistent result reporting.

In such implementations, a Missing Patch Remediation Layer handles the task of patch deployment and installation across multiple technologies. This layer operates at root/admin level across multiple machines, implementing standardized APIs for deployment scheduling and monitoring. The architecture supports complex patch installations, including those requiring specific installation sequences or environmental conditions, while maintaining a consistent deployment interface across different vendor technologies.

In such implementations, the Patch Information Independent Layer creates a comprehensive patch catalog through universal APIs, standardizing patch metadata across vendors. In example embodiments, the layer implements a Patch Data Translator that reads and writes patch data in any vendor format, enabling translation between different vendor formats through a standardized schema. The translator handles variations in naming conventions and creates a 'super set' of patch data using XML/JSON for data formatting.

The Patch Data Translator implements a universal schema that captures all essential patch metadata elements while maintaining compatibility with existing vendor formats. In example implementations, the Patch Data Translator operates through a three-stage process: first, it ingests vendor-specific patch data through format-specific adapters; second, it normalizes the data into the universal schema; and third, it can output the data in any supported vendor format while maintaining data integrity and relationship mapping.

In accordance with examples of the present disclosure, mixed-vendor deployment capabilities are enabled, in which organizations are allowed to combine agents, scanners, and remediation components from different vendors without system disruption. The architecture of the system disclosed supports both premium and economic solutions through plug-and-play component replacement, enabling cost-optimized configurations while maintaining security integrity. This technical framework provides improved security through broader patch coverage, reduced vulnerability windows, and multiple security approaches, while eliminating vendor lock-in constraints and enabling efficient component-level migration between service providers.

In example embodiments, the system supports both agent-based and agentless operations across clustered environments through standardized protocols implemented at each layer. In agent-based operations, the Agent Management Layer handles agent lifecycle management, while in agentless operations, it implements direct system access protocols. This flexibility enables organizations to choose the most appropriate operational mode for different segments of their infrastructure while maintaining consistent management capabilities. This technical architecture also maintains high performance while providing vendor independence, allowing organizations to implement best-of-breed component selection and comprehensive patch coverage without sacrificing operational efficiency or security effectiveness.

When operating in a clustered environment, the Missing Patch Remediation Layer coordinates patch deployment across cluster nodes to maintain service availability. The layer implements awareness of cluster configurations and manages patch installation sequences to prevent service disruption while ensuring comprehensive coverage.

The Patch Information Independent Layer maintains a comprehensive patch catalog that combines metadata from multiple vendors while preserving vendor-specific attributes. This catalog implements a flexible schema that captures all essential patch information, including vulnerability data, dependencies, and compatibility requirements. The layer's architecture enables rapid search and retrieval of patch information while maintaining relationships between related patches and affected applications.

The system implements cost optimization capabilities through the layered architecture. Organizations can implement premium solutions for critical systems while using economic solutions for less critical infrastructure, all managed through the same standardized interfaces. This technical framework enables component-level vendor migration without disrupting overall system operation, allowing organizations to adjust their patch management strategy based on operational requirements and budget constraints.

The system's standardized APIs implement comprehensive security controls while enabling broad patch coverage. Each layer includes security validation mechanisms to ensure proper authorization and authentication for management operations. The architecture implements defense-in-depth through multiple security approaches, including validation of patch sources, verification of patch integrity, and secure communication between components.

In specific implementations, the system can handle approximately 2,000 applications per machine through efficient cataloging and monitoring mechanisms. The Patch Scan Layer implements optimized scanning algorithms that minimize system impact while maintaining comprehensive coverage. The architecture disclosed herein enables efficient management of approximately 10,000 potential updates per machine through intelligent categorization and prioritization mechanisms.

The system implements specific technical mechanisms for handling variations in patch installation requirements across different platforms and applications. The Missing Patch Remediation Layer includes a rules engine that interprets complex installation requirements and translates them into platform-specific installation sequences. This engine handles dependencies, prerequisites, and post-installation validation while maintaining consistent management interfaces.

The architecture enables integration with existing computer management systems through standardized interfaces at each layer. The Agent Management Layer implements compatibility modes for existing vendor formats, allowing organizations to maintain existing management tools while transitioning to the new architecture. This technical approach minimizes disruption while enabling gradual migration to more efficient patch management processes.

In operation, the system maintains comprehensive audit trails of patch-related activities across all layers. Each layer implements logging mechanisms that capture relevant operational data while maintaining relationships between related activities. This technical capability enables detailed tracking of patch management operations while supporting compliance requirements and operational analysis.

The system implements specific technical mechanisms for handling emergency patch deployment scenarios. The Missing Patch Remediation Layer includes priority override capabilities that enable rapid deployment of critical patches while maintaining system stability. This mechanism implements intelligent scheduling algorithms that balance urgency with operational impact.

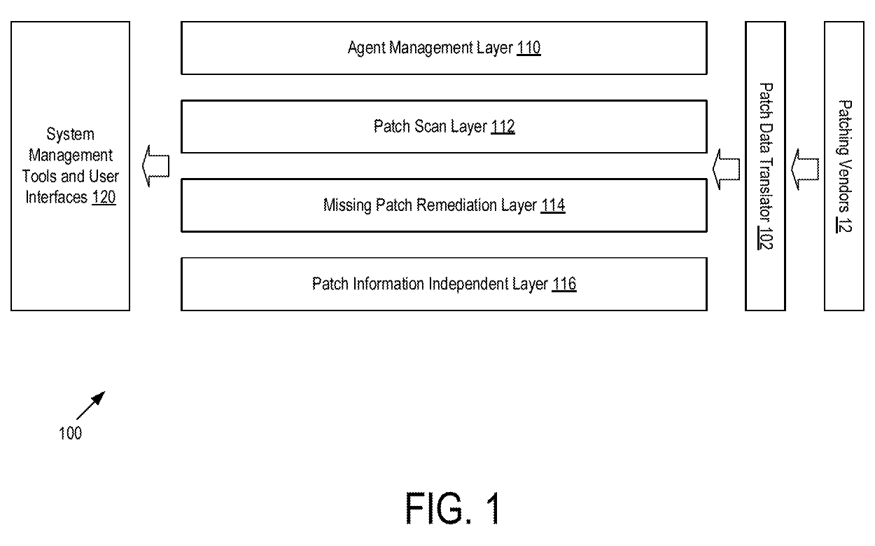

In addition to the layered architecture described above (and in conjunction with FIGS. 1-5), the present disclosure further provides enhanced systems and methods that extend patch management capabilities through the introduction of intelligent processing, adaptive data management, and automated lifecycle coordination. These additional capabilities may be implemented in conjunction with, or as extensions to, the previously described layered architecture, and may operate within the same vendor-independent framework.

In some embodiments, the system incorporates a repository intelligence layer configured to aggregate patch data from a plurality of heterogeneous sources and to normalize the data into a unified schema. The repository intelligence layer may further include mechanisms for detecting inconsistencies or failures in data ingestion and performing corrective actions to maintain continuity of patch data availability.

In certain implementations, the system includes automated mechanisms for maintaining patch data integrity in the presence of changing external data sources. For example, the system may detect failures in patch data retrieval processes, including conditions in which expected data is not returned, and may initiate corrective actions to recover missing data and update underlying data retrieval logic. These mechanisms enable continued operation of the system without interruption while adapting to changes in external data formats or interfaces.

Such capabilities improve reliability of patch data ingestion and reduce dependency on manual maintenance of data source integrations, thereby enabling more robust operation in dynamic environments.

In some embodiments, the system further includes an installation intelligence component configured to generate installation instructions for software patches based on patch metadata. The installation intelligence component may produce structured installation representations that are independent of specific platforms and may be translated into platform-specific execution strategies.

The system may further validate installation instructions prior to deployment using isolated execution environments. By executing installation instructions in a controlled environment and evaluating results using verification rules, the system may detect and correct errors before deployment to production systems, thereby improving reliability and reducing risk.

In certain implementations, the system includes an orchestration component configured to coordinate patch management operations using multiple processing modules or agents. These agents may perform functions such as prioritization of patches, detection of conflicts, determination of installation sequences, and evaluation of deployment results. The agents may operate cooperatively using shared data structures or communication mechanisms to produce coordinated patch deployment plans.

Such orchestration enables adaptive decision-making based on system context and patch characteristics, improving efficiency and effectiveness of patch management operations.

In some embodiments, patch management operations are performed as part of a closed-loop lifecycle in which results of patch deployment are captured and used to improve subsequent operations. The system may record information regarding deployment outcomes, analyze the information to identify patterns or issues, and update internal data structures, such as installation instructions or verification rules.

This feedback-driven approach enables continuous improvement of patch management processes over time, reducing failure rates and improving accuracy of future operations.

In certain implementations, the system may be deployed across a distributed computing environment including centralized control components and distributed execution components. The architecture may support scalable operation across multiple systems, geographic regions, or network segments, and may integrate with external systems through standardized interfaces.

FIG. 1 illustrates a high-level system architecture diagram of a layered API-driven patch management system 100, showing the four distinct functional layers and their interactions. The diagram depicts a comprehensive architecture where system management tools and user interfaces 120 connect at the top level to the system's layered components.

In the example shown, the topmost layer shows the Agent Management Layer 110, which implements standardized management APIs for handling endpoint communication across multiple agent types. The Agent Management Layer 110 enables the integration of diverse agent technologies and handles agent installation, updates, and deletion operations.

Below the Agent Management Layer 110, the Patch Scan Layer 112 implements unified APIs for identifying missing patches using multiple scanning technologies. This Patch Scan Layer 112 standardizes scan results format regardless of the underlying scanning technology used.

The third layer illustrated is the Missing Patch Remediation Layer 114, which handles patch deployment and installation across multiple technologies through standardized APIs. This Missing Patch Remediation Layer 114 operates at root/admin level across multiple machines and implements deployment scheduling and monitoring capabilities.

The Patch Information Independent Layer 116 is shown creating a comprehensive patch catalog through universal APIs. The Patch Information Independent Layer 116 includes the Patch Data Translator component 102, which enables conversion between vendor formats through standardized schema implementation.

The diagram also illustrates the interconnections between layers 110, 112, 114, 116 through standardized APIs, showing how data and commands flow between components while maintaining vendor independence. Multiple connections to vendors 12 are shown at appropriate layers, demonstrating the system's ability to integrate with various patch management vendors simultaneously.

The illustration includes visual representations of how multiple vendor components 12 can be integrated at each layer 110, 112, 114, 116, showing the system's capability for mixed-vendor deployment while maintaining operational consistency through the standardized interfaces.

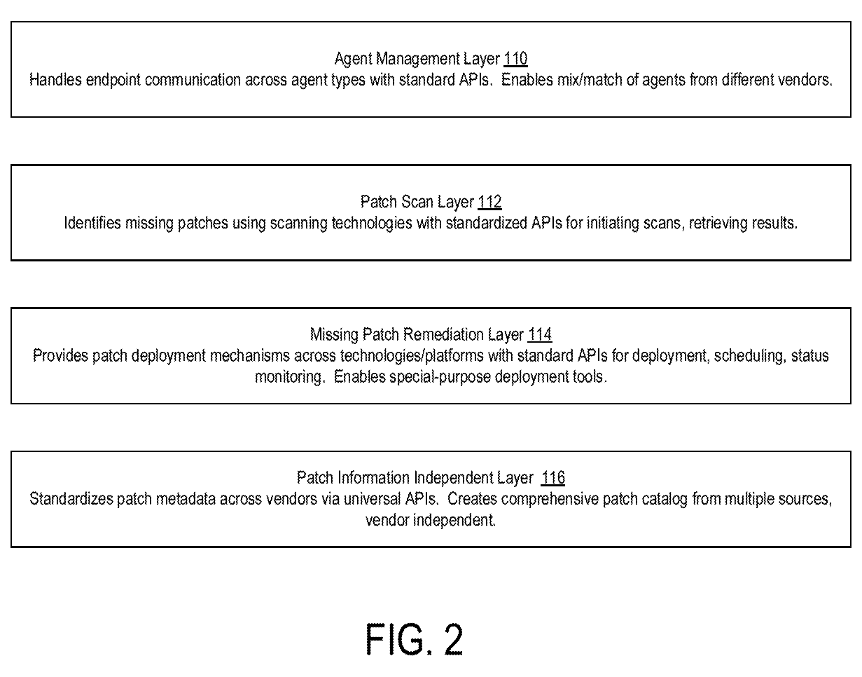

FIG. 2 illustrates the detailed technical implementation of the four primary layers 110, 112, 114, 116 of the system. The diagram shows how each layer operates independently while maintaining standardized communication interfaces. The Agent Management Layer 110 handles endpoint communications, the Patch Scan Layer 112 identifies missing patches, the Missing Patch Remediation Layer 114 manages deployment, and the Patch Information Independent Layer 116 standardizes metadata across vendors 12.

### Agent Management Layer

The Agent Management Layer 110 implements standardized management APIs that abstract the complexities of agent installation, updates, and deletion operations across different vendor technologies. This layer enables the integration of diverse agent types including IoT devices and Microsoft systems, while implementing efficient communication protocols that minimize network overhead.

The Agent Management Layer 110 handles both agent-based and agentless operations. In agent-based operations, it manages the complete agent lifecycle, while in agentless operations, it implements direct system access protocols. The Agent Management Layer 110 includes compatibility modes for existing vendor formats, allowing organizations to maintain existing management tools during transition periods.

### Patch Scan Layer

Operating above the Agent Management Layer 110, the Patch Scan Layer 112 implements multiple scanning technologies through a unified API interface. The Patch Scan Layer 112 identifies missing patches and installed applications across the managed environment, standardizing scan results format regardless of the underlying scanning technology used.

The Patch Scan Layer 112 architecture enables parallel operation of multiple scanning technologies, improving coverage while maintaining consistent result reporting. It implements optimized scanning algorithms that can efficiently manage thousands of applications per machine through cataloging and monitoring mechanisms.

### Missing Patch Remediation Layer

The Missing Patch Remediation Layer 114 handles patch deployment and installation across multiple technologies, operating at root/admin level across multiple machines. It implements standardized APIs for deployment scheduling and monitoring, supporting complex patch installations that require specific installation sequences or environmental conditions.

When operating in clustered environments, the Missing Patch Remediation Layer 114 coordinates patch deployment across cluster nodes to maintain service availability. It includes a rules engine that interprets complex installation requirements and translates them into platform-specific installation sequences, handling dependencies, prerequisites, and post-installation validation while maintaining consistent management interfaces.

### Patch Information Independent Layer

The Patch Information Independent Layer 116 creates a comprehensive patch catalog through universal APIs 320, standardizing patch metadata across vendors 12. The Patch Information Independent Layer 116 maintains a flexible schema that captures all essential patch information, including vulnerability data, dependencies, and compatibility requirements.

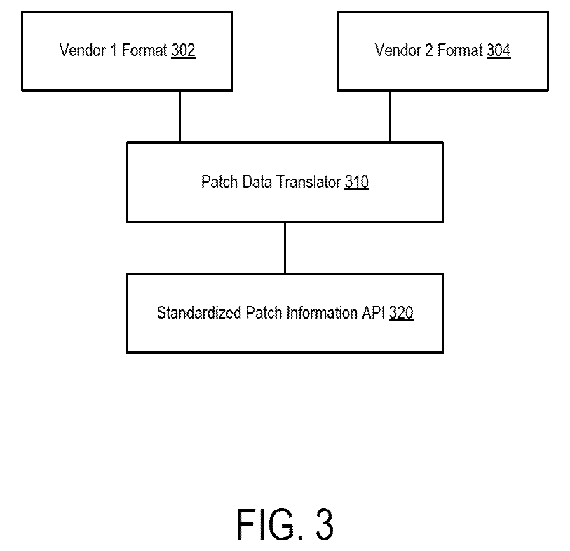

The Patch Information Independent Layer 116 implements a Patch Data Translator 102, 310 that reads and writes patch data in any vendor format 302, 304, enabling translation between different vendor formats through a standardized schema, as described below in conjunction with FIG. 3.

### Layer Integration and Communication

In the example shown, layers 110, 112, 114, 116 communicate through standardized APIs, enabling seamless integration while maintaining vendor independence. This architecture allows organizations to implement premium solutions for critical systems while using economic solutions for less critical infrastructure, all managed through the same standardized interfaces.

The layered architecture implements comprehensive security controls, with each layer 110, 112, 114, 116 including security validation mechanisms to ensure proper authorization and authentication for management operations. The architecture implements defense-in-depth through multiple security approaches, including validation of patch sources, verification of patch integrity, and secure communication between components.

FIG. 3 illustrates the architecture of the Patch Data Translator 310, showing how it enables conversion between different vendor formats 302, 304 through a standardized schema. The diagram demonstrates the translator's 310 capability to read and write patch data in multiple vendor formats, create unified patch catalogs, and facilitate seamless migration between vendors.

In the example shown, the Patch Data Translator 310 operates through a three-stage process:
1. Data Ingestion: The Patch Data Translator 310 ingests vendor-specific patch data from Vendor 1 Format 302 and Vendor 2 Format 304 through format-specific adapters, handling variations in naming conventions and data structures.
2. Data Normalization: The ingested data is normalized into a universal schema that standardizes common elements including:
   File versions and file names
   Registry key information (handling variations like "regkey" vs "registry key")
   Security vulnerability identifiers (such as CVE IDs)
   Patch metadata and dependencies
3. Data Output: The normalized data can be output through the Standardized Patch Information API 320 in any supported vendor format 302, 304 while maintaining data integrity and relationship mapping.

The Patch Data Translator 310 implements XML/JSON formatting for data standardization, creating a superset of patch data that combines metadata from multiple vendors 12 while preserving vendor-specific attributes. This enables reading and writing patch data in any vendor format 302, 304, translation between different vendor-specific formats, creation of unified patch catalogs, and seamless migration between vendors or suppliers.

The Patch Data Translator 310 maintains compatibility with existing vendor formats 302, 304 through field mapping between different vendor formats using standardized schemas, handling of variations in naming conventions and data structures, preservation of vendor-specific attributes while enabling standardized access through API 320, and implementation of compatibility modes for existing vendor formats.

The Patch Data Translator 310 enables organizations to combine data from multiple vendors 12 into a comprehensive patch catalog, maintain existing tools and scripts while transitioning between vendors, export data in formats 302, 304 compatible with major patch vendors, and create super sets of patch data from multiple sources.

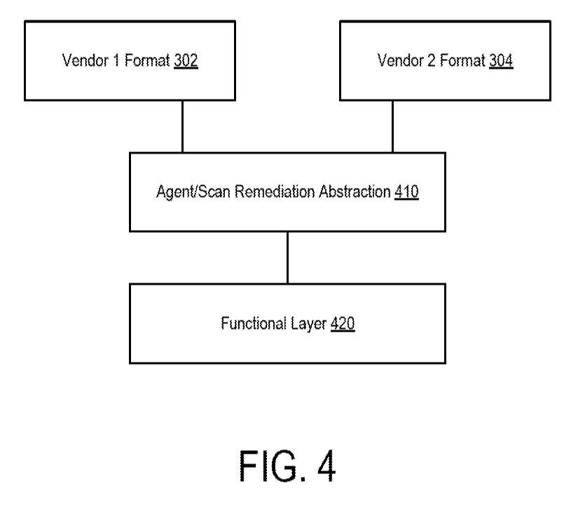

FIG. 4 illustrates the technology abstraction implementation, showing how the system handles different vendor formats 302, 304 through standardized functional layers. The diagram demonstrates how vendor-specific formats are abstracted through the Agent/Scan/Remediation Abstraction layer 410 to enable vendor-independent operations through the Functional Layer 420.

The figure demonstrates the data flow between multiple vendor agents and the Agent Management Layer 110, showing how the layer 110 handles endpoint communication across diverse agent types including IoT devices and Microsoft systems. The standardized APIs enable seamless integration of these diverse agent technologies without requiring code rewrites.

The diagram illustrates how the Agent Management Layer 110 implements efficient communication protocols that minimize network overhead while supporting both agent-based and agentless operations. In agent-based operations, the layer 110 handles agent lifecycle management, while in agentless operations, it implements direct system access protocols.

The illustration shows how multiple vendor agents can be combined at the Agent Management Layer 110 through the Agent/Scan/Remediation Abstraction 410, demonstrating the system's plug-and-play component replacement capabilities without system disruption. This enables organizations to optimize costs by selecting appropriate components for different operational requirements while maintaining consistent management interfaces through the Functional Layer 420.

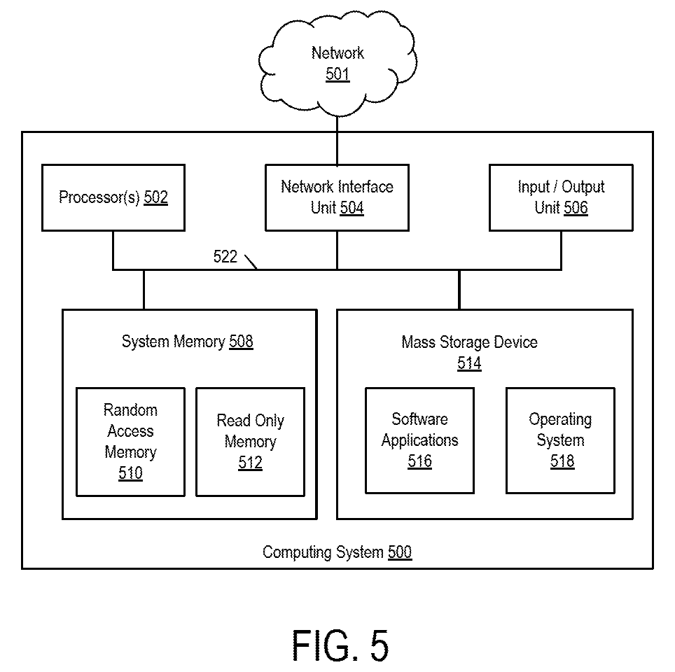

FIG. 5 illustrates an example block diagram of a virtual or physical computing system 500. One or more aspects of the computing system 500 can be used to implement the processes described herein.

In the embodiment shown, the computing system 500 includes one or more processors 502, a system memory 508, and a system bus 522 that couples the system memory 508 to the one or more processors 502. The system memory 508 includes RAM (Random Access Memory) 510 and ROM (Read-Only Memory) 512. A basic input/output system that contains the basic routines that help to transfer information between elements within the computing system 500, such as during startup, is stored in the ROM 512. The computing system 500 further includes a mass storage device 514. The mass storage device 514 is able to store software instructions and data 516. The one or more processors 502 can be one or more central processing units or other processors.

The mass storage device 514 is connected to the one or more processors 502 through a mass storage controller (not shown) connected to the system bus 522. The mass storage device 514 and its associated computer-readable data storage media provide non-volatile, non-transitory storage for the computing system 500. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 500.

According to various embodiments of the invention, the computing system 500 may operate in a networked environment using logical connections to remote network devices through the network 501. The network 501 is a computer network, such as an enterprise intranet and/or the Internet. The network 501 can include a LAN, a Wide Area Network (WAN), the Internet, wireless transmission mediums, wired transmission mediums, other networks, and combinations thereof. The computing system 500 may connect to the network 501 through a network interface unit 504 connected to the system bus 522. It should be appreciated that the network interface unit 504 may also be utilized to connect to other types of networks and remote computing systems. The computing system 500 also includes an input/output controller 506 for receiving and processing input from a number of other devices, including a touch user interface display screen, or another type of input device. Similarly, the input/output controller 506 may provide output to a touch user interface display screen or other type of output device.

As mentioned briefly above, the mass storage device 514 and the RAM 510 of the computing system 500 can store software instructions and data. The software instructions include an operating system 518 suitable for controlling the operation of the computing system 500. The mass storage device 514 and/or the RAM 510 also store software instructions, that when executed by the one or more processors 502, cause one or more of the systems, devices, or components described herein to provide functionality described herein. For example, the mass storage device 514 and/or the RAM 510 can store software instructions that, when executed by the one or more processors 502, cause the computing system 500 to receive and execute the processes described herein.

Referring to the present disclosure generally, the disclosed computing system provides a physical environment with which aspects of the systems described herein may be implemented. Still further, while particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For example, while certain technologies described herein were primarily described in the context of multi-supplier or multi-vendor patch management coexistence, technologies disclosed herein are applicable to data and methods for performing patch management operations.

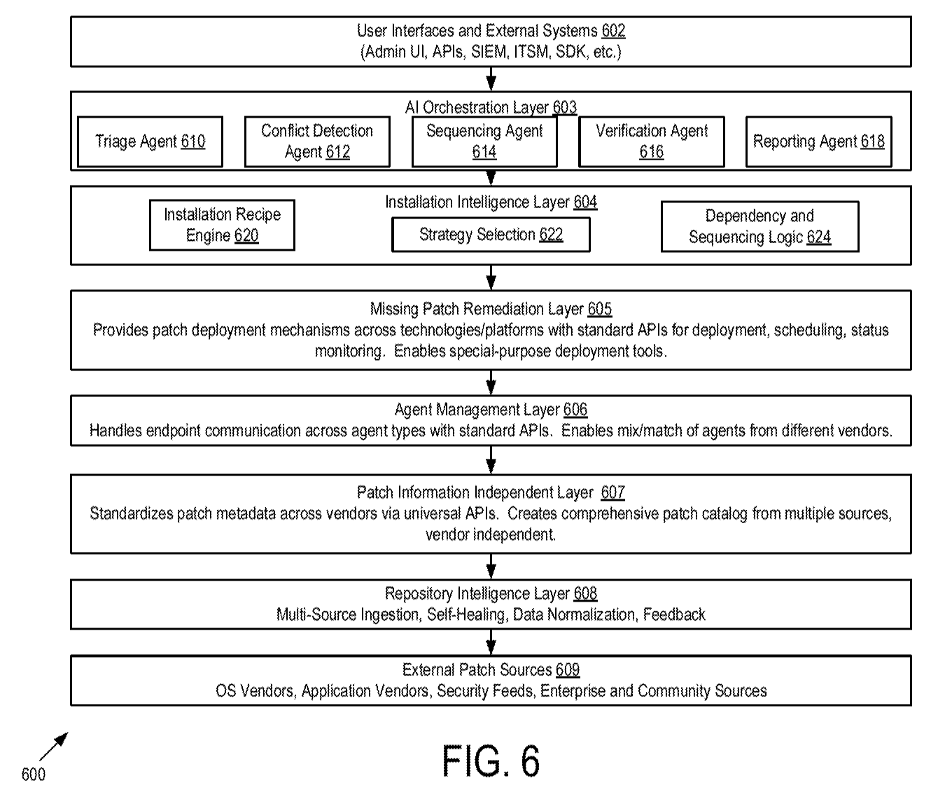

FIG. 6 illustrates an example of an expanded layered patch management architecture 600 according to aspects of the present disclosure. The architecture 600 extends the core layered system described in connection with FIGS. 1–4 by incorporating additional intelligence and orchestration capabilities while maintaining a vendor-independent, API-driven framework.

As shown in FIG. 6, the architecture 600 includes a plurality of logical layers configured to communicate via standardized interfaces, enabling modular operation and interoperability among components. In the illustrated embodiment, the architecture 600 includes user interfaces and external systems 602, an AI orchestration layer 603, an installation intelligence layer 604, a missing patch remediation layer 605, an agent management layer 606, a patch information independent layer 607, and a repository intelligence layer 608. The architecture further interfaces with a plurality of external patch sources 609.

The user interfaces and external systems 602 may include administrative interfaces, application programming interfaces (APIs), security information and event management (SIEM) systems, information technology service management (ITSM) systems, software development kits (SDKs), or other external systems configured to interact with the architecture 600. These interfaces enable users and external tools to initiate scanning, deployment, reporting, and configuration operations.

The AI orchestration layer 603 is configured to coordinate patch management operations using a plurality of software agents. In the illustrated embodiment, the AI orchestration layer 603 includes a triage agent 610, a conflict detection agent 612, a sequencing agent 614, a verification agent 616, and a reporting agent 618. These agents may operate sequentially, in parallel, or in an event-driven manner, and may exchange information through shared data structures or messaging mechanisms. The triage agent 610 may prioritize patches based on one or more risk factors, the conflict detection agent 612 may identify incompatibilities among patches, the sequencing agent 614 may determine an installation order, the verification agent 616 may evaluate deployment outcomes, and the reporting agent 618 may generate output for various stakeholders.

The installation intelligence layer 604 is positioned below the AI orchestration layer 603 and is configured to generate and manage installation instructions for patches. The installation intelligence layer 604 includes an installation recipe engine 620, a strategy selection component 622, and dependency and sequencing logic 624. The installation recipe engine 620 may generate normalized installation instructions based on patch metadata. The strategy selection component 622 may select a platform-specific installation strategy, such as for different operating systems or package managers. The dependency and sequencing logic 624 may enforce ordering constraints, prerequisites, and relationships among patches.

The missing patch remediation layer 605 is configured to execute patch deployment operations across one or more computing systems. The remediation layer 605 may provide standardized APIs for deployment, scheduling, and monitoring. In some embodiments, the remediation layer 605 may support complex installation scenarios, including coordinated updates across clustered systems or environments requiring specific execution conditions.

The agent management layer 606 is configured to manage communication with endpoint systems. The agent management layer 606 may support both agent-based and agentless operations and may handle lifecycle management of agents, including installation, updating, and removal. The agent management layer 606 may provide standardized communication interfaces that abstract underlying vendor-specific agent implementations.

The patch information independent layer 607 is configured to maintain a unified patch catalog. This layer standardizes patch metadata across multiple vendors using a vendor-independent schema. The patch information independent layer 607 may store information such as patch identifiers, versions, dependencies, and vulnerability data, and may provide APIs for querying and retrieving such information.

The repository intelligence layer 608 is configured to ingest, normalize, and maintain patch data from the external patch sources 609. The repository intelligence layer 608 may implement multi-source ingestion, self-healing mechanisms, data normalization, and feedback-driven updates. For example, the repository intelligence layer 608 may detect failures in data ingestion processes and perform corrective actions, including retrieving data from alternative sources or modifying ingestion logic. The repository intelligence layer 608 may further update the unified patch catalog based on newly ingested or corrected data.

The external patch sources 609 may include operating system vendors, application vendors, security advisory feeds, enterprise data sources, and community-contributed data. These sources may provide patch metadata in a variety of formats, which are ingested and normalized by the repository intelligence layer 608.

In operation, data may flow from the external patch sources 609 into the repository intelligence layer 608, where the data is normalized and incorporated into the patch information independent layer 607. The agent management layer 606 and patch scan layer (not shown in FIG. 6 but described in connection with other figures) may interact with endpoint systems to identify missing patches. The AI orchestration layer 603 may analyze the results and generate deployment plans, which are executed by the remediation layer 605 using instructions produced by the installation intelligence layer 604.

The layered structure illustrated in FIG. 6 enables separation of concerns among components while allowing coordinated operation through standardized interfaces. The architecture 600 supports vendor-independent operation, extensibility, and integration with a wide range of external systems. In addition, the incorporation of the AI orchestration layer 603 and repository intelligence layer 608 enables adaptive and self-improving behavior across patch management operations.

Although specific layers and components are illustrated in FIG. 6, it should be understood that additional layers may be included, certain layers may be combined, and the ordering of layers may vary without departing from the scope of the present disclosure.

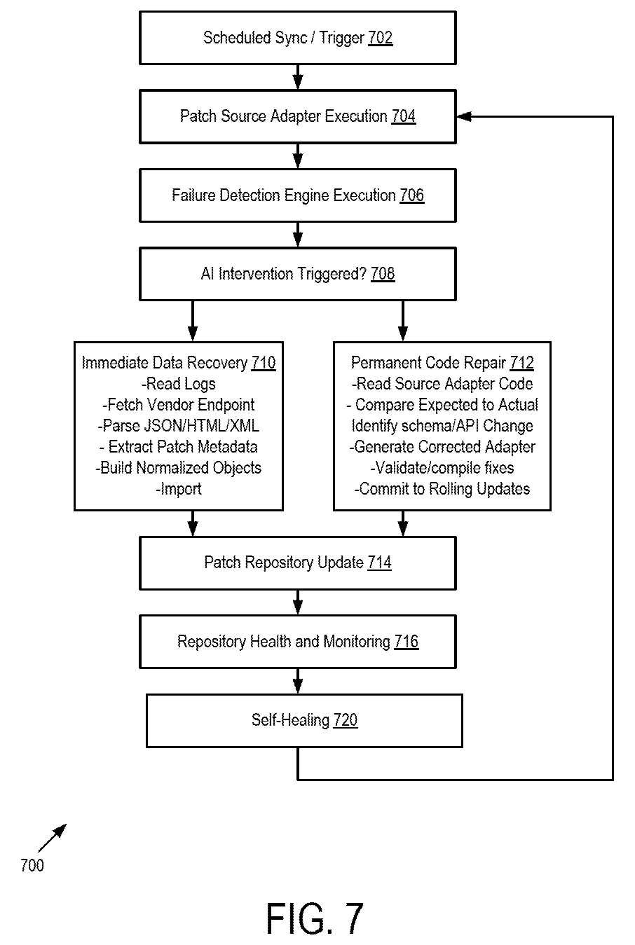

FIG. 7 illustrates an example process 700 for maintaining and updating a patch repository using a self-healing mechanism according to aspects of the present disclosure. The process 700 may be implemented, for example, by the repository intelligence layer described in connection with FIG. 6, although other implementations are possible.

As shown, the process 700 begins with a scheduled synchronization or trigger event 702. The scheduled trigger 702 may be time-based, event-driven, or initiated by a user or external system. In response to the trigger 702, a patch source adapter execution stage 704 is performed. During stage 704, a plurality of source adapters may be executed, each configured to retrieve patch data from a corresponding external patch data source. The external sources may include vendor APIs, structured feeds, web-based sources, or other data providers.

Following execution of the source adapters, a failure detection engine 706 evaluates the results of the adapter execution. The failure detection engine 706 may detect both explicit failures, such as network errors or parsing exceptions, and silent failures, such as situations in which an adapter completes execution but returns no patch data or incomplete data. Detection of silent failures may be based on comparison to expected results, historical baselines, or other heuristics.

At decision stage 708, a determination is made as to whether an intervention is required. If no failure is detected, the process may proceed directly to repository update operations. If a failure is detected, an automated recovery process is initiated.

In the illustrated embodiment, the recovery process includes two parallel recovery paths: an immediate data recovery path 710 and a permanent code repair path 712. These paths may be executed concurrently or independently.

In the immediate data recovery path 710, the system may analyze failure information, including logs or error messages, and directly access the external patch source to retrieve patch data. This may include fetching data from vendor endpoints, parsing structured or unstructured content (such as JSON, XML, or HTML), extracting patch metadata, constructing normalized patch objects, and importing the extracted data into the repository. This path enables continued operation of the system by ensuring that patch data remains available even when source adapters are malfunctioning.

In the permanent code repair path 712, the system may analyze the source adapter implementation associated with the failure. This may include comparing expected data formats to actual data returned by the external source, identifying schema changes, API modifications, or structural differences, and generating a modified adapter configured to accommodate the changes. The modified adapter may be validated, compiled, or otherwise tested, and may be stored or committed for use in subsequent synchronization operations.

Following execution of one or both recovery paths, a patch repository update stage 714 is performed. During this stage, normalized patch data is incorporated into a repository, which may include deduplication, correlation, and integration with existing patch metadata.

A repository health and monitoring stage 716 may then be performed. The monitoring stage 716 may evaluate repository integrity, completeness, and consistency, including validation of patch counts, detection of anomalies, and assessment of data quality.

The process further includes a self-healing feedback stage 720, in which the system incorporates information obtained during recovery and monitoring into subsequent operations. For example, repaired adapters may be used in future synchronization cycles, and detection heuristics may be updated based on observed failures. The feedback mechanism enables the system to improve reliability and reduce recurrence of failures over time.

The process 700 enables continuous maintenance of patch data in the presence of changing external data sources. By combining immediate data recovery with longer-term adapter correction, the system maintains availability of patch data while adapting to changes in external source formats.

Although the process is illustrated as including specific stages, it should be understood that additional stages may be included, certain stages may be omitted, and stages may be performed in different orders or concurrently without departing from the scope of the present disclosure.

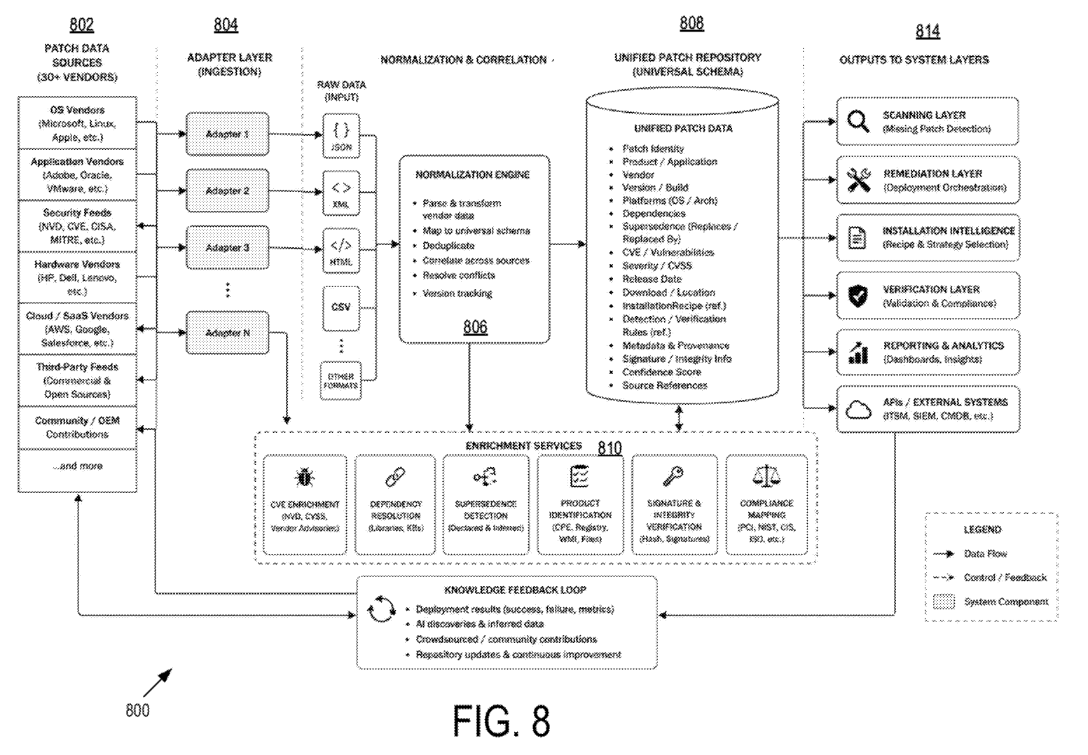

FIG. 8 illustrates an example patch data aggregation and processing pipeline 800 according to aspects of the present disclosure. The pipeline 800 may be implemented, for example, within the repository intelligence layer described in connection with FIG. 6, and is configured to ingest, normalize, enrich, and distribute patch data obtained from a plurality of heterogeneous sources.

As shown, the pipeline 800 begins with a plurality of patch data sources 802. The patch data sources 802 may include operating system vendors, application vendors, security advisory feeds, package repositories, enterprise data sources, and community-provided data. These sources may provide patch data in a variety of formats, including structured formats (e.g., JSON or XML), semi-structured formats, or unstructured formats (e.g., HTML content).

Patch data from the patch data sources 802 is provided to a source adapter layer 804. The source adapter layer 804 includes a plurality of adapters configured to interface with respective patch data sources. Each adapter may implement source-specific logic for retrieving, parsing, and extracting patch data, including handling variations in protocols, authentication mechanisms, and data formats.

Data extracted by the source adapter layer 804 is provided to a data normalization engine 806. The data normalization engine 806 is configured to transform vendor-specific patch data into a standardized representation. This may include mapping fields from source-specific schemas to a unified schema, resolving differences in naming conventions, standardizing data types, and ensuring consistency across data obtained from different sources.

The normalized data is then stored within a universal patch schema 808. The universal patch schema 808 represents a superset data model capable of storing patch information from multiple vendors. In various embodiments, the schema may include patch identifiers, product and version information, file metadata, vulnerability information, dependency relationships, and detection rules.

Following normalization, the pipeline 800 may perform additional processing within a data enrichment and correlation stage 810. The enrichment stage 810 may augment the normalized patch data with additional information obtained from one or more external or internal sources. For example, the enrichment stage 810 may associate vulnerability identifiers (e.g., CVE identifiers), severity scores, exploit information, or dependency relationships with patch records. The enrichment stage 810 may also perform correlation across multiple sources to identify related patches or consolidate redundant data.

In some embodiments, a field mapping component may operate in conjunction with the data normalization engine 806. The field mapping component may maintain mappings between different vendor-specific field names and the corresponding fields in the universal patch schema 808. This mapping may enable flexible integration of new data sources and facilitate bidirectional translation between formats.

The processed data is then provided to a format translation and export layer. The format translation and export layer is configured to convert data from the universal patch schema 808 into one or more target formats. These target formats may include vendor-specific formats, standardized APIs, or custom formats required by downstream systems. The translation may be bidirectional, enabling both ingestion and export of patch data across different formats.

The output of the format translation and export layer is provided to downstream system integrations 814. The downstream system integrations 814 may include patch scanning systems, remediation systems, third-party management tools, or other systems that consume patch data. These integrations may access the data through standardized APIs or other interfaces.

In some embodiments, the pipeline 800 further includes a feedback mechanism (not explicitly numbered in the figure) that allows downstream systems to provide information back to the pipeline. Such feedback may include validation results, corrections, or additional metadata, which may be incorporated into subsequent processing operations within the pipeline.

The pipeline 800 enables aggregation of patch data from diverse sources into a unified and enriched dataset, while maintaining compatibility with existing vendor formats and supporting integration with downstream systems. By separating ingestion, normalization, enrichment, and translation functions into distinct stages, the pipeline provides flexibility, scalability, and extensibility.

Although specific components are illustrated in FIG. 8, it should be understood that additional components may be included, certain components may be combined or omitted, and the ordering of operations may vary without departing from the scope of the present disclosure.

In accordance with aspects of the present disclosure, the term “installation recipe” refers to a structured representation of instructions and associated metadata that define how a software patch is to be installed, verified, and managed within a computing environment.

In some embodiments, an installation recipe may be represented as a data structure that is independent of any specific execution platform or vendor implementation. The installation recipe may include a plurality of fields that collectively describe installation behavior, execution parameters, and validation criteria associated with a patch. For example, an installation recipe may include one or more of: an identifier associated with a patch; information identifying a target product, version, or platform; an installation method or classification (e.g., executable installer, package manager, system update mechanism); a reference to an installer location, such as a download URL or repository reference; one or more execution parameters, including command-line arguments or configuration settings; dependency or prerequisite information specifying conditions required for installation; expected execution outcomes, including one or more success exit codes; one or more verification rules configured to determine whether installation was successful; and a confidence level indicating a reliability or validation status of the recipe.

In certain embodiments, the installation recipe provides a normalized and platform-independent abstraction that can be translated into one or more platform-specific execution strategies. For example, a single installation recipe may be used to generate different executable commands depending on characteristics of a target computing system, such as operating system, architecture, or available package management systems.

In some implementations, installation recipes may be generated automatically based on patch metadata. For example, an installation recipe may be inferred by analyzing installer file types, vendor-specific conventions, platform characteristics, or other information associated with a patch. In certain embodiments, artificial intelligence techniques may be used to derive or refine installation recipes.

In some embodiments, installation recipes may be validated prior to deployment. For example, an installation recipe may be executed within an isolated execution environment, such as a container or virtual machine, and results of the execution may be evaluated using the verification rules associated with the recipe. Based on validation outcomes, the installation recipe may be modified, refined, or assigned an updated confidence level.

In certain implementations, installation recipes may be stored in a repository and reused across multiple patch deployment operations. The repository may maintain historical information associated with each recipe, including execution results, validation outcomes, and contextual information about computing environments in which the recipe has been applied.

In some embodiments, installation recipes may be updated over time based on observed behavior during deployment. For example, failures or anomalies encountered during installation may result in modifications to the recipe, which may then be revalidated and stored for future use. In this manner, installation recipes provide a flexible, extensible, and reusable mechanism for defining patch installation behavior across heterogeneous computing environments while supporting automation, validation, and continuous improvement.

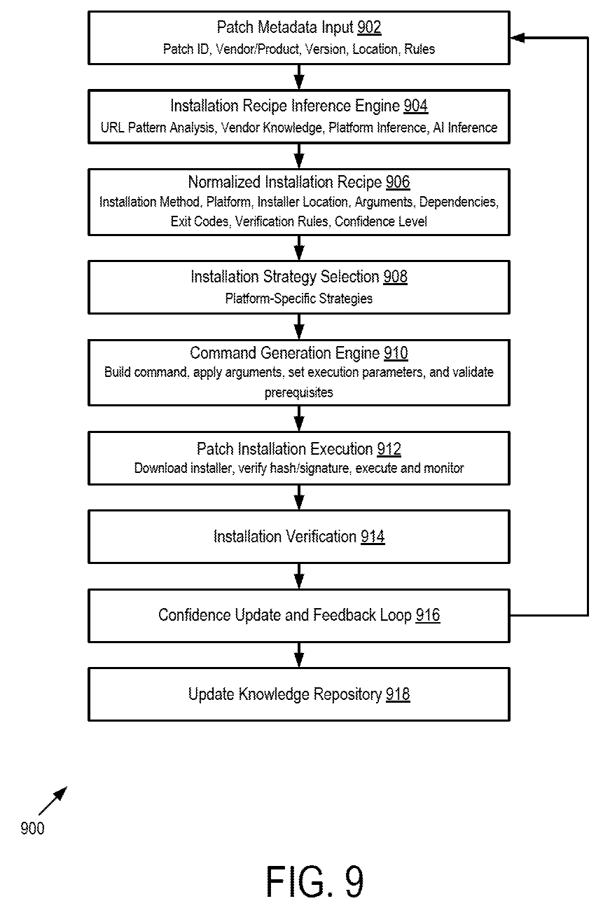

FIG. 9 illustrates an example installation recipe generation and execution process 900 according to aspects of the present disclosure. The process 900 may be implemented, for example, by the installation intelligence layer described in connection with FIG. 6, and is configured to generate, execute, and refine installation instructions for software patches.

As shown, the process 900 begins with patch metadata input 902. The patch metadata input 902 may include information such as a patch identifier, vendor and product information, version data, a location or download reference, and one or more detection rules associated with the patch. The patch metadata input 902 may be obtained from the patch repository described in connection with FIG. 8.

The patch metadata input 902 is provided to an installation recipe inference engine 904. The installation recipe inference engine 904 is configured to generate installation instructions based on the patch metadata. In various embodiments, the inference engine 904 may perform one or more inference operations, including analysis of installer file types or locations, application of vendor-specific knowledge, determination of target platform characteristics, and use of artificial intelligence techniques to derive installation parameters. The inference engine 904 may produce a structured representation of installation instructions.

The output of the installation recipe inference engine 904 is a normalized installation recipe 906. The normalized installation recipe 906 may include fields such as an installation method, a target platform, an installer location, execution arguments, dependency information, expected exit codes, one or more verification rules, and a confidence level associated with the generated instructions. The normalized installation recipe 906 provides a platform-independent representation of how a patch is to be installed.

The normalized installation recipe 906 is then provided to an installation strategy selection stage 908. The installation strategy selection stage 908 is configured to select a platform-specific installation strategy based on characteristics of the patch and the target computing environment. For example, different strategies may be selected for different operating systems, package managers, or installer types.

Following selection of an installation strategy, a command generation engine 910 generates executable commands. The command generation engine 910 may construct one or more commands based on the normalized installation recipe 906 and the selected strategy, including applying execution arguments, setting parameters, and validating prerequisites required for installation.

The generated commands are executed during a patch installation execution stage 912. During this stage 912, the system may download an installer from the specified location, verify integrity using hash or signature validation, and execute the installation process. The execution stage 912 may also monitor runtime behavior, including capturing output and exit codes.

Following execution, an installation verification stage 914 is performed. The installation verification stage 914 may evaluate whether the patch was successfully installed. In some embodiments, verification may be performed using one or more rules derived from the patch metadata, such as checking file versions, registry entries, or package states.

Results of the verification stage 914 are provided to a confidence update and feedback loop stage 916. The feedback loop stage 916 may update the confidence level associated with the normalized installation recipe 906 based on observed outcomes. For example, successful installation and verification may increase confidence, while failures may trigger refinement of the recipe.

Finally, an update knowledge repository stage 918 is performed. In this stage, information obtained during execution and verification may be stored in a repository, including validated installation recipes, observed behaviors, and updated confidence levels. This information may be used to improve future installation operations.

The process 900 enables automated generation and refinement of installation instructions, supporting cross-platform deployment and continuous improvement through feedback. By separating inference, strategy selection, execution, and verification into distinct stages, the process provides flexibility and extensibility across diverse patch management scenarios.

Although the process 900 is illustrated as including specific stages, it should be understood that additional stages may be included, certain stages may be omitted, and stages may be performed in different orders or concurrently without departing from the scope of the present disclosure.

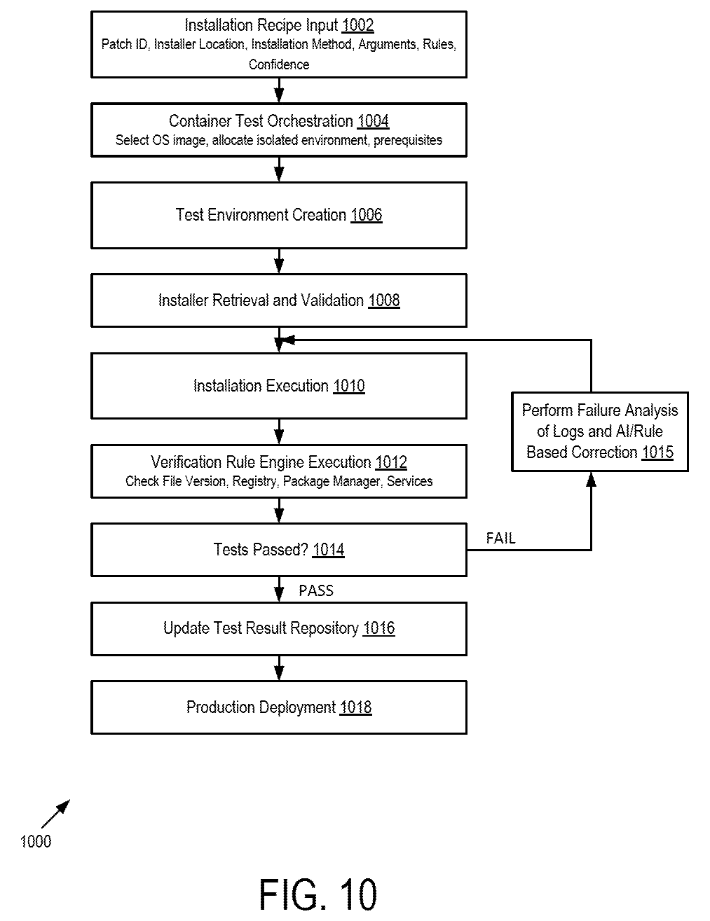

FIG. 10 illustrates an example process 1000 for validating installation instructions using an isolated execution environment according to aspects of the present disclosure. The process 1000 may be implemented, for example, by the installation intelligence layer and repository intelligence layer described in connection with FIG. 6, and may operate in conjunction with the installation recipe generation process described in FIG. 9.

As shown, the process 1000 begins with an installation recipe input 1002. The installation recipe input 1002 may include information such as a patch identifier, installer location, installation method, execution arguments, one or more verification rules, and an associated confidence level. The installation recipe input 1002 may be generated by the installation recipe inference engine described in FIG. 9 or retrieved from a repository of previously validated recipes.

The installation recipe input 1002 is provided to a container test orchestration stage 1004. The container test orchestration stage 1004 is configured to prepare an isolated execution environment for testing the installation instructions. This may include selecting an appropriate operating system image, allocating resources, and identifying prerequisites required for execution.

Following orchestration, a test environment creation stage 1006 is performed. The test environment creation stage 1006 may instantiate an isolated execution environment, such as a container or virtual machine, configured to emulate a target computing environment. The environment may include a filesystem, runtime services, and network configuration suitable for executing installation instructions.

An installer retrieval and validation stage 1008 then obtains the installer associated with the patch. This stage 1008 may include downloading the installer from a specified location, verifying integrity using cryptographic hashes or digital signatures, and confirming that the installer corresponds to expected metadata.

After retrieval, an installation execution stage 1010 is performed. During this stage, the installation instructions defined by the installation recipe are executed within the isolated environment. Execution may include invoking a platform-specific installer, applying execution arguments, and capturing runtime outputs such as standard output, standard error, and exit codes.

Following execution, a verification rule engine execution stage 1012 evaluates the results of the installation. The verification rule engine execution stage 1012 may apply one or more verification rules, such as checking file versions, registry values, package manager states, or service statuses, to determine whether the installation achieved the intended system state.

At decision stage 1014, a determination is made as to whether the validation tests passed. If the tests are successful, the process proceeds to a test result repository update stage 1016. In this stage 1016, information regarding the test execution, including success status, environment configuration, and verification results, may be stored in a repository. The validated installation recipe may be marked as suitable for production deployment.

If the tests do not pass, the process proceeds to a failure analysis and correction stage 1015. In this stage 1015, the system may analyze logs, error messages, and execution results to determine causes of failure. The system may then modify the installation instructions, such as adjusting execution parameters, adding prerequisites, or selecting alternative strategies. In some embodiments, this modification may be performed using rule-based logic or artificial intelligence techniques.

Following correction, the modified installation instructions may be re-evaluated by returning to one or more earlier stages of the process, such as the installation execution stage 1010 or the orchestration stage 1004, thereby forming an iterative validation loop.

Upon successful validation, the process proceeds to a production deployment stage 1018. In this stage 1018, validated installation instructions may be used for deployment to target computing systems, thereby reducing the likelihood of installation failures in production environments.

The process 1000 provides a mechanism for validating installation instructions prior to deployment, enabling detection and correction of errors in a controlled environment. By performing validation in isolation, the system reduces risk to production systems and improves reliability of patch deployment operations.

Although the process 1000 is illustrated with specific stages, it should be understood that additional stages may be included, certain stages may be omitted, and stages may be performed in different orders or concurrently without departing from the scope of the present disclosure.

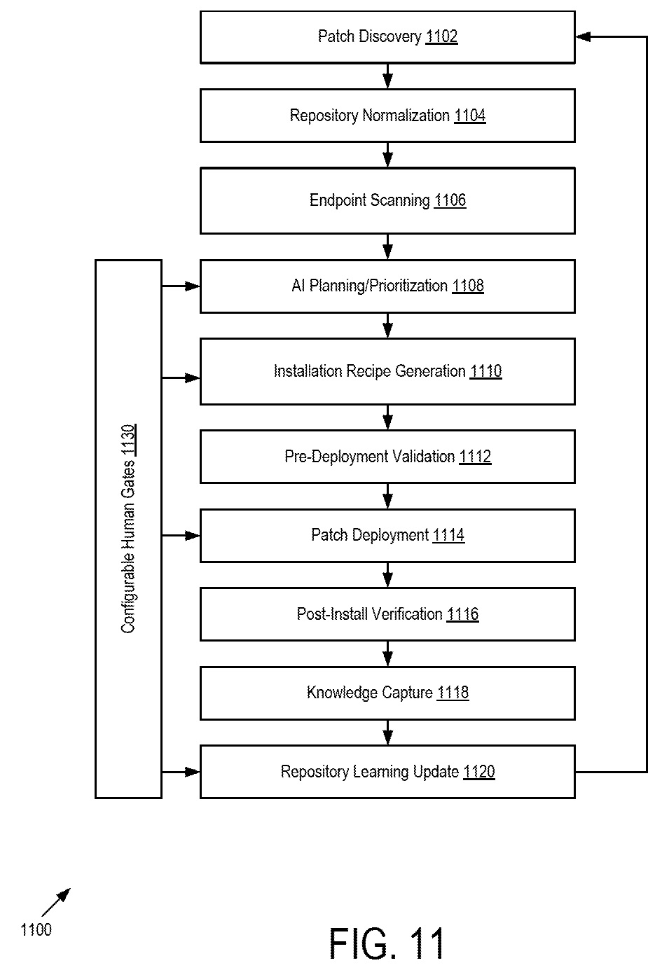

FIG. 11 illustrates an example process 1100 representing an end-to-end patch management lifecycle according to aspects of the present disclosure. The process 1100 may be implemented by the layered architecture described in connection with FIG. 6 and may operate in conjunction with the data aggregation, installation, validation, and learning processes described in FIGS. 7–10 and 12–13.

As shown, the process 1100 begins with a patch discovery stage 1102. In this stage 1102, patch information may be obtained from one or more external sources, including vendor feeds, security advisories, or other data repositories. The discovered patch data may include information such as patch identifiers, affected products, versions, and vulnerability data.

Following discovery, a repository normalization stage 1104 is performed. During this stage 1104, patch data is normalized into a unified schema, such as the universal patch schema described in connection with FIG. 8. Normalization may include mapping vendor-specific fields, resolving naming inconsistencies, and standardizing metadata.

The normalized data is then used in an endpoint scanning stage 1106. In this stage 1106, one or more computing systems are evaluated to determine installed software and identify missing patches. The scanning may be performed using one or more detection rules and may involve agent-based or agentless mechanisms.

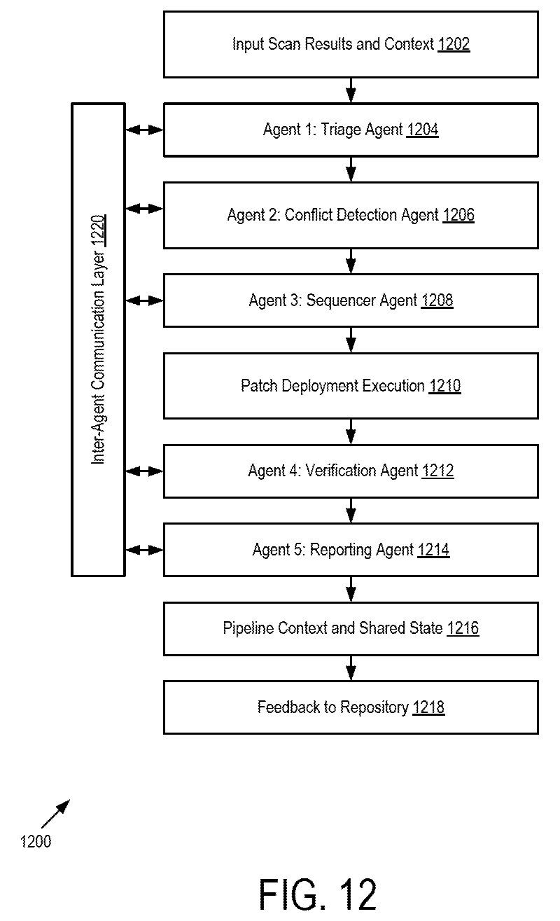

Results of the scanning stage 1106 are provided to an artificial intelligence planning and prioritization stage 1108. In this stage 1108, patch deployment decisions may be determined based on one or more factors, such as severity of vulnerabilities, likelihood of exploitation, system role, or operational constraints. In some embodiments, this stage may be implemented using one or more software agents, such as those described in FIG. 12.

Following planning, an installation recipe generation stage 1110 is performed. In this stage 1110, installation instructions are generated for identified patches, such as by using the installation recipe inference process described in FIG. 9. The generated instructions may include installation methods, execution parameters, dependencies, and verification rules.

A pre-deployment validation stage 1112 may then be performed. In this stage 1112, installation instructions may be validated prior to deployment, such as by executing the instructions within an isolated environment as described in FIG. 10. Validation may identify errors or inconsistencies in the instructions before they are applied to production systems.

Following validation, a patch deployment stage 1114 is performed. During this stage 1114, validated installation instructions are executed on target computing systems. Deployment may include downloading installers, executing installation commands, coordinating updates across multiple systems, and managing system states such as reboots or service interruptions.

After deployment, a post-install verification stage 1116 is performed. In this stage 1116, the system evaluates whether patches have been successfully applied. Verification may include reapplying detection rules, checking file versions, evaluating system configuration, or confirming expected system behavior.

Results from the verification stage 1116 are then used in a knowledge capture stage 1118. During this stage 1118, information regarding installation outcomes, including successes, failures, and anomalies, is recorded. The captured information may include execution logs, system state changes, and contextual information about the target systems.

A repository learning update stage 1120 follows. In this stage 1120, information captured during deployment and verification is used to update the patch repository. Updates may include refinement of installation instructions, modification of verification rules, or enrichment of patch metadata. The updated repository may improve the effectiveness of future patch management operations.

The process 1100 further includes configurable human gates 1130. The human gates 1130 may represent optional intervention points at which user input or approval may be required. For example, approval may be required prior to deployment, prior to accepting repository updates, or when handling exceptional conditions. In some embodiments, these gates may be enabled or disabled based on policy or configuration.

The process 1100 forms a continuous lifecycle in which outputs of later stages influence earlier stages in subsequent iterations. For example, updates generated in the repository learning update stage 1120 may affect future patch discovery, normalization, and planning operations, thereby forming a closed-loop system that improves over time.

Although the process 1100 is illustrated as a sequence of stages, it should be understood that stages may be performed in different orders, combined, or executed concurrently without departing from the scope of the present disclosure.

FIG. 12 illustrates an example process 1200 for coordinating patch management operations using a plurality of software agents according to aspects of the present disclosure. The process 1200 may be implemented, for example, by the AI orchestration layer described in connection with FIG. 6, and may operate in conjunction with the lifecycle process described in FIG. 11.

As shown, the process 1200 begins with input scan results and context 1202. The input 1202 may include data obtained from endpoint scanning operations, such as identified missing patches, installed software, system configurations, and contextual information about target computing systems. The contextual information may include attributes such as system role, network exposure, or operational constraints.

The input 1202 is provided to a triage agent 1204. The triage agent 1204 is configured to analyze the scan results and assign priorities to patches. In some embodiments, the triage agent 1204 may evaluate one or more risk factors, such as severity, vulnerability data, or likelihood of exploitation, to determine which patches should be addressed first.

The prioritized output from the triage agent 1204 is then provided to a conflict detection agent 1206. The conflict detection agent 1206 is configured to analyze relationships among patches to identify potential incompatibilities or conflicts. For example, the conflict detection agent 1206 may determine whether installation of one patch may interfere with another or whether certain patches require mutually exclusive system states.

The output of the conflict detection agent 1206 is provided to a sequencing agent 1208. The sequencing agent 1208 is configured to determine an order for installing patches based on dependencies, conflicts, and operational considerations. The sequencing agent 1208 may generate an installation plan that specifies a sequence of patch deployment steps.

Following generation of the installation plan, a patch deployment execution stage 1210 is performed. In this stage 1210, the system executes the installation plan by deploying patches to target computing systems using installation instructions generated as described in FIG. 9.

After execution, a verification agent 1212 evaluates the results of patch deployment. The verification agent 1212 may analyze post-installation system state, compare expected and actual outcomes, and determine whether installation was successful. The verification agent 1212 may also identify anomalies or incomplete installations.

The results of verification are then provided to a reporting agent 1214. The reporting agent 1214 is configured to generate output based on the patch management process. Such output may include summaries, logs, or structured reports suitable for consumption by users or external systems.

Throughout the process 1200, data may be maintained within a pipeline context and shared state 1216. The shared state 1216 may store intermediate results generated by each agent, enabling communication and coordination among the agents. In some embodiments, the shared state 1216 may include data structures representing prioritized patches, detected conflicts, installation plans, and verification results.

The process 1200 may further include an inter-agent communication layer 1220. The inter-agent communication layer 1220 may provide mechanisms for exchanging information among agents, such as message queues, event streams, or shared memory structures. This layer enables flexible coordination among agents and supports different execution models, including sequential, parallel, or asynchronous operation.

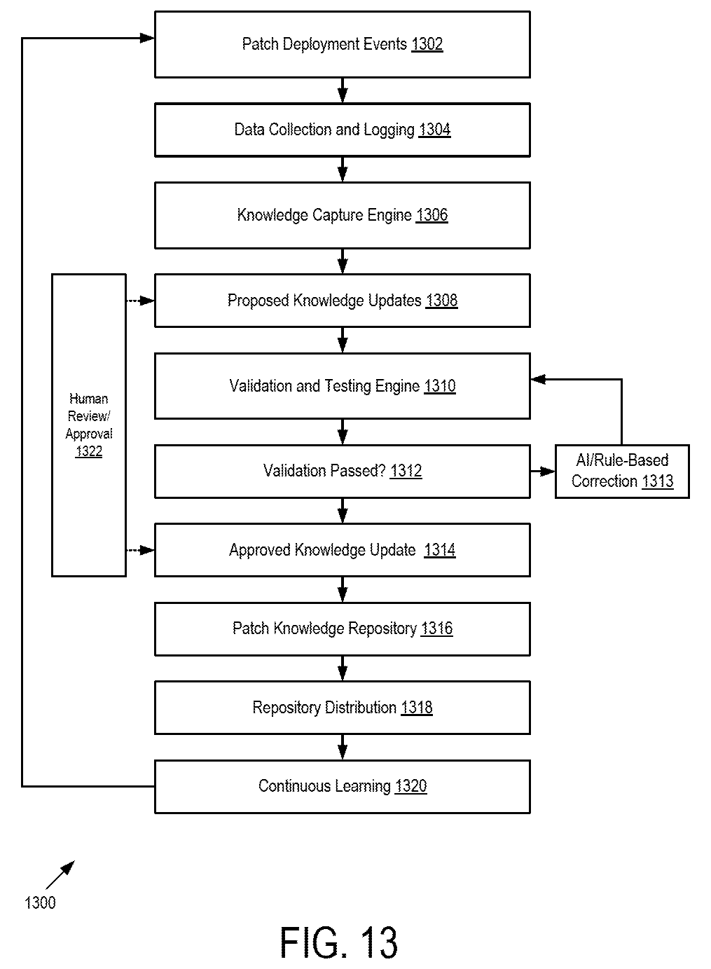

Outputs generated by the process 1200 may be provided to a feedback stage 1218. In the feedback stage 1218, results of the patch management process may be incorporated into a repository or lifecycle system, such as the knowledge feedback process described in FIG. 13. This feedback may be used to improve subsequent patch management operations.

The process 1200 enables modular and coordinated patch management using specialized software agents. By dividing responsibilities among multiple agents and enabling structured communication, the system can adapt to varying conditions and optimize patch deployment decisions.

Although the process 1200 is illustrated as a sequence of stages, it should be understood that the agents may operate in different orders, concurrently, or in an event-driven manner without departing from the scope of the present disclosure.

FIG. 13 illustrates an example process 1300 for capturing, validating, and incorporating knowledge derived from patch deployment operations according to aspects of the present disclosure. The process 1300 may be implemented, for example, by the repository intelligence layer and AI orchestration layer described in connection with FIG. 6, and may operate in conjunction with the lifecycle process described in FIG. 11.

As shown, the process 1300 begins with patch deployment events 1302. The patch deployment events 1302 may include outcomes of patch installation operations, such as successful installations, failed installations, partial completions, or anomalous behaviors observed during execution.

Information associated with the patch deployment events 1302 is collected during a data collection and logging stage 1304. In this stage 1304, the system may capture execution data including logs, exit codes, verification results, system state information, and contextual attributes of the computing systems on which patches were deployed.

The collected data is then processed by a knowledge capture engine 1306. The knowledge capture engine 1306 is configured to analyze the collected data and extract relevant information that may improve future patch management operations. This may include identifying patterns in successful installations, determining causes of failures, detecting dependencies among patches, and recognizing environmental conditions that affect deployment outcomes.

Based on the output of the knowledge capture engine 1306, proposed knowledge updates 1308 are generated. The proposed knowledge updates 1308 may include modifications or additions to patch-related data, such as new or updated installation recipes, refined verification rules, corrected dependency relationships, or enhanced metadata associated with patches.

The proposed knowledge updates 1308 are provided to a validation and testing engine 1310. The validation and testing engine 1310 is configured to evaluate the proposed updates to ensure correctness and consistency. In some embodiments, validation may include schema validation, execution of installation instructions in isolated environments, consistency checks against existing data, or conflict detection.

At decision stage 1312, a determination is made as to whether the validation is successful. If validation is successful, the process proceeds to an approved knowledge update stage 1314. In this stage 1314, the validated updates are incorporated into a patch knowledge repository 1316.

If validation is not successful, the process proceeds to a correction stage 1313. In this stage 1313, the system may analyze validation failures and modify the proposed updates. Such modifications may be performed using rule-based logic or artificial intelligence techniques. The modified updates may then be re-evaluated by returning to the validation and testing engine 1310, thereby forming an iterative validation loop.

In some embodiments, the process 1300 may include an optional human review and approval stage 1322. The human review and approval stage 1322 may provide an opportunity for user intervention before incorporating updates into the repository. For example, administrators may review proposed updates, approve or reject changes, or modify updates prior to approval.

Following approval, the updates are stored in the patch knowledge repository 1316. The patch knowledge repository 1316 may maintain data such as installation instructions, verification rules, dependency information, and metadata associated with patches.

The updated repository data is then made available during a repository distribution stage 1318. In this stage 1318, updated knowledge may be distributed to other components of the system, such as scanning processes, installation engines, or orchestration components.

A continuous learning stage 1320 reflects the ongoing nature of the process 1300. In this stage 1320, knowledge incorporated into the repository is used to improve subsequent patch management operations. For example, updated installation instructions may reduce failure rates, and refined verification rules may improve detection accuracy.

The process 1300 forms a feedback loop in which deployment outcomes are used to refine and improve the system over time. By capturing and validating knowledge derived from operational data, the system enables adaptive behavior and continuous improvement in patch management processes.

Although the process 1300 is illustrated with specific stages, it should be understood that additional stages may be included, certain stages may be omitted, and stages may be performed in different orders or concurrently without departing from the scope of the present disclosure.

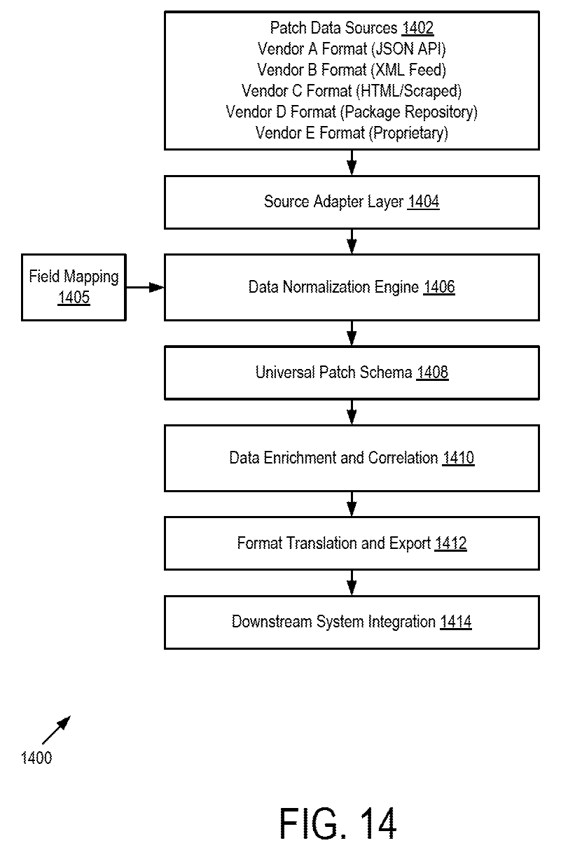

FIG. 14 illustrates an example system 1400 for translating and integrating patch data from multiple heterogeneous sources according to aspects of the present disclosure. The system 1400 may be implemented, for example, by the patch information independent layer and repository intelligence layer described in connection with FIG. 6, and may operate in conjunction with the aggregation pipeline described in FIG. 8.

As shown, the system 1400 includes a plurality of patch data sources 1402. The patch data sources 1402 may include multiple vendor-specific formats, such as structured application programming interfaces (APIs), XML feeds, web-based content, package repositories, or proprietary data formats. For example, the patch data sources 1402 may include a first vendor format provided via a JSON API, a second vendor format provided via an XML feed, a third vendor format obtained through scraping of web-based content, a fourth vendor format obtained from a package repository, and a fifth vendor format provided in a proprietary schema.

Data from the patch data sources 1402 is received by a source adapter layer 1404. The source adapter layer 1404 includes a plurality of adapters configured to interface with respective patch data sources. Each adapter may implement source-specific logic for retrieving data, handling communication protocols, parsing content, and extracting relevant patch metadata. The source adapter layer 1404 may accommodate differences in authentication, transport mechanisms, and data structures across sources.

The extracted data is then provided to a data normalization engine 1406. The data normalization engine 1406 is configured to convert vendor-specific data representations into a standardized format. This may include mapping source-specific field names to corresponding fields in a unified schema, standardizing data types, resolving inconsistencies in naming conventions, and ensuring that data obtained from different sources conforms to a consistent representation.

In some embodiments, a field mapping component 1405 operates in conjunction with the data normalization engine 1406. The field mapping component 1405 may maintain mappings between vendor-specific field identifiers and corresponding fields in the unified schema. For example, different vendors may use different terms for similar concepts, and the field mapping component 1405 may resolve such differences to enable consistent representation within the system.

Normalized data is stored within a universal patch schema 1408. The universal patch schema 1408 represents a vendor-independent data model capable of storing patch metadata from multiple sources. The schema may include, for example, patch identifiers, product and version information, file metadata, vulnerability identifiers, dependency relationships, and detection rules. The universal patch schema 1408 may be structured as a superset of vendor-specific schemas, enabling preservation of vendor-specific attributes while providing standardized access.

Following normalization, the data may be processed within a data enrichment and correlation stage 1410. The data enrichment and correlation stage 1410 may augment the normalized data with additional information obtained from internal or external sources. For example, the system may associate vulnerability identifiers, severity scores, or dependency relationships with patch records. The correlation process may also identify relationships among patches from different sources, such as duplicate entries, superseding patches, or related updates.

The processed data is then provided to a format translation and export stage 1412. The format translation and export stage 1412 is configured to convert data from the universal patch schema 1408 into one or more target formats. These target formats may include vendor-specific formats, standardized APIs, or formats required by downstream systems. The translation may be bidirectional, enabling both ingestion of vendor-specific data and export to vendor-compatible formats.

Output from the format translation and export stage 1412 is provided to downstream system integration components 1414. The downstream system integrations 1414 may include patch scanning systems, remediation systems, management platforms, or third-party tools. These systems may access the translated data through standardized interfaces, enabling interoperability without requiring modification of the downstream systems.

The system 1400 enables integration of patch data from diverse sources into a unified representation while maintaining compatibility with multiple vendor formats. By separating data ingestion, normalization, enrichment, and translation into distinct components, the system provides flexibility, scalability, and extensibility for patch management operations.

Although specific components are illustrated in FIG. 14, it should be understood that additional components may be included, certain components may be combined or omitted, and operations may be performed in different orders or concurrently without departing from the scope of the present disclosure.

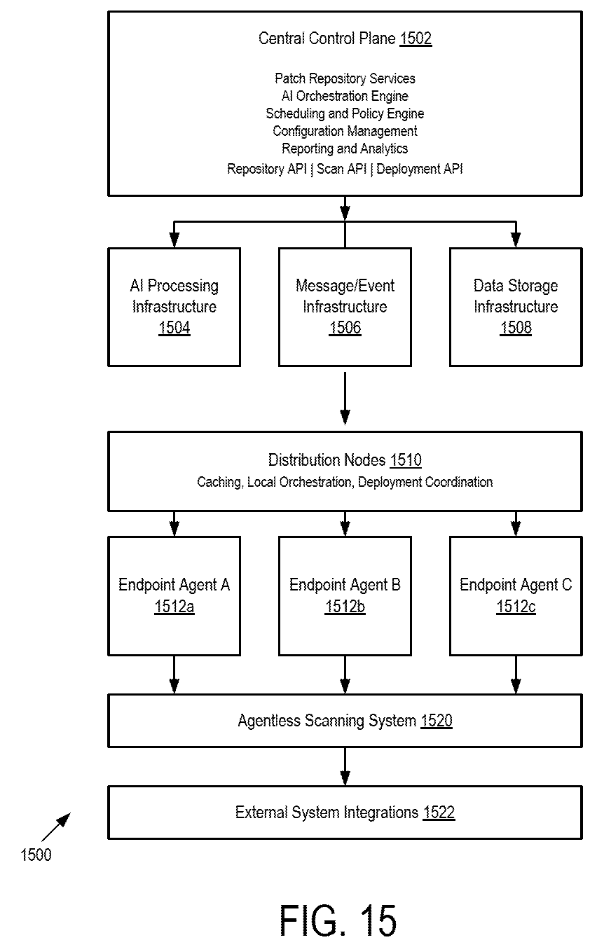

FIG. 15 illustrates an example distributed patch management system architecture 1500 according to aspects of the present disclosure. The architecture 1500 may be implemented, for example, using the layered system described in connection with FIG. 6, and may support scalable deployment across enterprise or cloud-based environments.

As shown, the architecture 1500 includes a central control plane 1502. The central control plane 1502 may provide coordination and management functions for patch management operations. In various embodiments, the central control plane 1502 may include patch repository services, an AI orchestration engine, a scheduling and policy engine, configuration management functionality, and reporting and analytics capabilities. The central control plane 1502 may expose one or more interfaces, such as a repository API, a scan API, and a deployment API, to enable interaction with other components of the system.

The central control plane 1502 is coupled to an AI processing infrastructure 1504. The AI processing infrastructure 1504 may include computing resources configured to perform artificial intelligence or machine learning operations, such as inference, analysis, or decision-making. These operations may support functions such as patch prioritization, anomaly detection, or generation of installation instructions.

The architecture 1500 further includes a message and event infrastructure 1506. The message and event infrastructure 1506 may facilitate communication among components of the system through mechanisms such as message queues, event streams, or publish-subscribe systems. This infrastructure enables asynchronous and event-driven coordination across distributed components.

A data storage infrastructure 1508 is also included. The data storage infrastructure 1508 may store patch data, installation data, telemetry, logs, and other information used by the system. In some embodiments, the data storage infrastructure 1508 may include one or more databases, data lakes, or distributed storage systems.

The central control plane 1502 may communicate with one or more distribution nodes 1510. The distribution nodes 1510 may be geographically or logically distributed and may provide functions such as caching patch data, performing local orchestration, and coordinating deployment activities within a region or network segment. The distribution nodes 1510 may reduce latency and bandwidth usage by handling operations closer to endpoint systems.

The distribution nodes 1510 may interact with a plurality of endpoint agents, such as endpoint agent A 1512a, endpoint agent B 1512b, and endpoint agent C 1512c. Each endpoint agent may be deployed on a corresponding computing system and may be configured to perform local operations such as scanning for missing patches, executing installation instructions, and reporting results. The endpoint agents 1512a–1512c may communicate with the distribution nodes 1510 or directly with the central control plane 1502 using standardized interfaces.

In addition to agent-based operations, the architecture 1500 may include an agentless scanning system 1520. The agentless scanning system 1520 may be configured to perform scanning operations on computing systems without requiring installation of local agents. Such scanning may be performed using remote access protocols, system interfaces, or network-based techniques.

The architecture 1500 may further include external system integrations 1522. The external system integrations 1522 may include connections to external platforms such as security information and event management (SIEM) systems, configuration management databases (CMDBs), IT service management (ITSM) systems, or cloud management platforms. These integrations enable the patch management system to exchange data with other enterprise systems.

In operation, the central control plane 1502 may coordinate patch management activities across distributed components. For example, patch data may be stored in the data storage infrastructure 1508 and distributed to distribution nodes 1510. The distribution nodes 1510 may coordinate patch deployment to endpoint agents 1512a–1512c, which execute installation instructions and report results. The message and event infrastructure 1506 may facilitate communication among components, while the AI processing infrastructure 1504 may provide analysis and decision-making capabilities.

The distributed architecture 1500 enables scalable and resilient patch management across large and diverse computing environments. By separating control, processing, storage, and execution functions into distinct components, the system supports efficient operation across distributed networks and varying deployment models.

Although specific components are illustrated in FIG. 15, it should be understood that additional components may be included, certain components may be combined or omitted, and communication paths may vary without departing from the scope of the present disclosure.

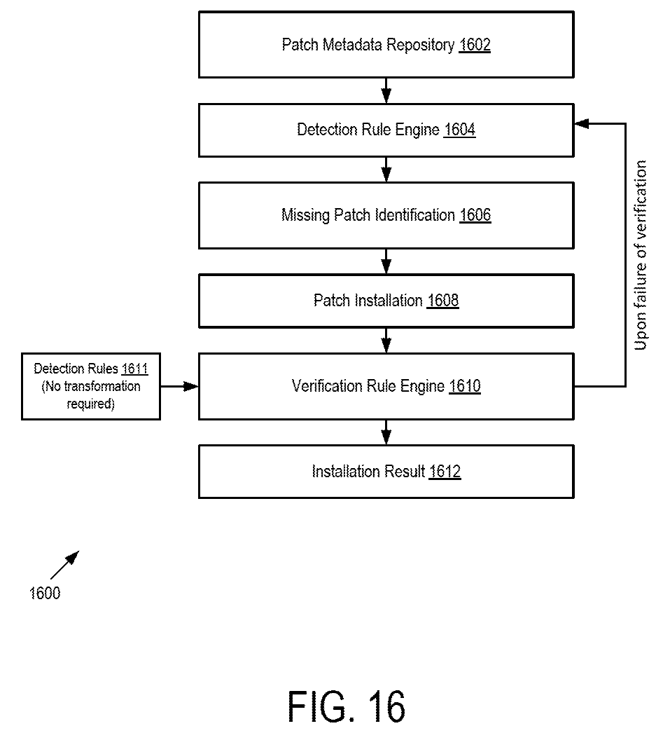

FIG. 16 illustrates an example process 1600 for applying a unified set of rules for both detection of missing patches and verification of successful patch installation according to aspects of the present disclosure. The process 1600 may be implemented, for example, by the patch scan layer and the installation intelligence layer described in connection with FIG. 6, and may operate in conjunction with the lifecycle and validation processes described in FIGS. 9–11.

As shown, the process 1600 begins with a patch metadata repository 1602. The patch metadata repository 1602 may store patch-related information, including one or more detection rules associated with each patch. The detection rules may define conditions used to determine whether a patch is installed or missing on a computing system. Such rules may include, for example, file version checks, registry value checks, or package version comparisons.

The detection rules stored in the patch metadata repository 1602 are applied during a detection rule engine stage 1604. In the detection rule engine stage 1604, the system evaluates the detection rules against a target computing system to determine whether a patch is present. The evaluation may include accessing system state information, such as files, configuration settings, or installed packages.

Based on the evaluation performed by the detection rule engine 1604, a missing patch identification stage 1606 determines whether one or more patches are absent from the computing system. If a patch is determined to be missing, the process proceeds to a patch installation stage 1608.

In the patch installation stage 1608, installation instructions corresponding to the identified patch are executed. The installation instructions may be generated as described in connection with FIG. 9 and may include platform-specific commands, execution parameters, and dependency handling.

Following execution of the installation instructions, a verification rule engine stage 1610 is performed. In the verification rule engine stage 1610, the system evaluates whether the patch has been successfully installed. Notably, the verification rule engine stage 1610 reuses the same detection rules 1611 that were used in the detection rule engine stage 1604. As illustrated, the detection rules 1611 are applied without transformation to verify the post-installation system state.

The reuse of detection rules 1611 enables the system to evaluate whether the installation has achieved the desired system state using the same criteria that were used to detect absence of the patch. For example, a rule that determines that a file version is below a threshold during detection may be reused to verify that the file version meets or exceeds the threshold after installation.

The results of the verification rule engine stage 1610 are provided to an installation result stage 1612. In the installation result stage 1612, the system determines whether the patch installation was successful based on the verification results. If verification indicates success, the process may conclude for the patch. If verification indicates failure, the system may initiate corrective actions, such as reattempting installation, modifying installation instructions, or triggering escalation processes.

The process 1600 demonstrates a dual-purpose use of detection rules for both identifying missing patches and verifying successful installation. By reusing the same rules in both contexts, the system reduces the need for separate rule definitions and ensures consistency between detection and verification operations.

Although the process 1600 is illustrated as a sequence of stages, it should be understood that additional stages may be included, certain stages may be omitted, and stages may be performed in different orders or concurrently without departing from the scope of the present disclosure.

In addition to the aspects described above, further aspects of the present disclosure may include additional features, configurations, and operational modes associated with the layered patch management system.

In some embodiments, the system may include a repository intelligence component configured to detect failures in patch data ingestion processes and perform automated recovery operations. Such failures may include explicit errors as well as silent failures in which expected patch data is not returned. In response to detection of such failures, the system may perform parallel recovery operations, including retrieving patch data directly from external sources and modifying one or more data ingestion components to correct underlying issues. These operations may be performed concurrently such that patch data remains available while ingestion mechanisms are corrected.

In certain embodiments, the system may validate installation instructions using an isolated execution environment prior to deployment. For example, installation instructions may be executed within a containerized or virtualized environment configured to emulate a target computing system. The system may evaluate execution results using one or more verification rules and may iteratively modify the installation instructions based on observed failures. In some implementations, the system may assign a confidence level to installation instructions based on validation outcomes and may selectively deploy only those instructions that meet a confidence threshold.

In some embodiments, the system may generate installation instructions using a plurality of inference techniques, including analysis of patch metadata, vendor-specific conventions, file types, or platform characteristics. The system may further select among multiple installation strategies based on target environment attributes, including operating system, architecture, or available package management systems. Such strategies may include execution of platform-specific installers, package manager commands, or other deployment mechanisms.

In certain embodiments, patch management operations may be coordinated using a plurality of software agents configured to perform specialized functions. Such agents may include, for example, agents for prioritization, conflict detection, sequencing, verification, and reporting. The agents may operate sequentially, in parallel, or in an event-driven manner and may exchange data through shared data structures, message queues, or other communication mechanisms. Outputs generated by one agent may be used as inputs to another agent to form a coordinated processing pipeline.

In some embodiments, patch management operations may be performed as part of a closed-loop lifecycle in which outputs of later stages influence earlier stages in subsequent iterations. For example, the system may capture results of patch deployment operations, including success, failure, and contextual information, and may use this information to update installation instructions, verification rules, or patch metadata stored in a repository. Such updates may improve subsequent patch management operations over time.

In certain embodiments, the system may include a knowledge capture mechanism configured to generate proposed updates to patch-related data based on operational results. The proposed updates may include new or modified installation instructions, verification rules, dependency relationships, or metadata.

The system may validate such updates using one or more techniques, including schema validation, isolated execution, or consistency checks. In some implementations, updates may be subject to optional human review prior to incorporation into a repository.

In some embodiments, one or more rules used to detect missing patches may be reused to verify successful installation of patches. For example, rules used to determine that a patch is absent may be reapplied after installation to determine whether the patch is present. Such reuse of rules may occur without transformation, thereby reducing configuration complexity and ensuring consistency between detection and verification operations.

In certain embodiments, the system may be implemented in a distributed computing environment including a centralized control plane and one or more distributed execution components. The distributed components may include endpoint agents, regional nodes, or agentless scanning mechanisms. The system may support both agent-based and agentless operations and may coordinate patch deployment across multiple computing systems, network segments, or geographic regions.

In some embodiments, the system may include a data translation mechanism configured to convert patch data between multiple vendor-specific formats and a unified schema. The translation mechanism may support bidirectional conversion and may enable interoperability with existing systems without requiring modification of such systems. The system may further maintain mappings between different vendor-specific field representations and corresponding fields in the unified schema.

In certain embodiments, the system may identify relationships among patches, including dependencies and supersedence relationships. For example, the system may determine that installation of a first patch supersedes one or more other patches and may adjust deployment plans accordingly. Such relationships may be derived from vendor-provided data, inferred from file version comparisons, or determined through analysis of patch metadata.

In some embodiments, the system may iteratively refine patch management operations based on observed failures. For example, failure of installation instructions may trigger analysis of execution data and generation of modified instructions, which may be re-evaluated in subsequent iterations. Such iterative processing may be performed using rule-based logic, artificial intelligence techniques, or combinations thereof.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A computer-implemented patch management system comprising:
a processor; and
a memory storing instructions that, when executed by the processor, cause the processor to:
maintain a patch knowledge repository configured to aggregate patch data from a plurality of heterogeneous patch data sources associated with different vendors;
normalize the patch data into a vendor-independent schema;
execute a plurality of logically distinct layers communicating through standardized application programming interfaces (APIs), the layers comprising:
an agent management layer configured to manage communication with one or more computing systems;
a patch scan layer configured to detect missing patches using one or more detection rules;
a remediation layer configured to deploy patches to the one or more computing systems; and
a patch information layer configured to maintain metadata associated with patches;
execute an installation intelligence layer configured to generate installation instructions for patches based on the normalized patch data; and
execute an orchestration layer configured to coordinate patch management operations across the plurality of layers,
wherein the system enables integration of components from multiple vendors without requiring modification of the components.

2. The system of claim 1, wherein the orchestration layer is further configured to:
detect a failure or inconsistency in a patch management operation;
modify one or more inputs, parameters, or installation instructions associated with the operation; and
re-execute at least a portion of the patch management operation using the modified inputs until a defined success condition is satisfied.

3. The system of claim 1, wherein the plurality of layers further comprises a repository intelligence layer configured to perform data ingestion, normalization, and feedback processing.

4. The system of claim 1, wherein the layers are independently replaceable without affecting operation of other layers.

5. The system of claim 1, wherein the system supports simultaneous use of components from multiple vendors.

6. The system of claim 1, further comprising a data translation component configured to convert patch data between vendor-specific formats, and wherein the data translation component maps fields from vendor-specific schemas into the vendor-independent schema.

7. The system of claim 6, wherein the data translation component outputs patch data in a selected vendor-specific format.

8. The system of claim 1, wherein the patch knowledge repository includes vulnerability data associated with patches.

9. The system of claim 1, wherein the patch knowledge repository stores dependency relationships between patches.

10. The system of claim 1, wherein the patch knowledge repository identifies superseded patches based on version relationships.

11. The system of claim 1, wherein the installation instructions are generated based on one or more of file type, vendor-specific conventions, or platform characteristics.

12. The system of claim 11, wherein the installation instructions include one or more installation parameters and one or more verification rules.

13. The system of claim 1, further comprising a triage agent configured to prioritize patches based on vulnerability severity.

14. The system of claim 1, wherein the system includes a centralized control plane and a plurality of distributed agents.

15. The system of claim 14, wherein the distributed agents execute patch deployment operations locally, and the system supports agentless scanning of computing systems.

16. The system of claim 1, further comprising a recovery subsystem configured to identify changes in data source schemas and modify source adapter code to accommodate the changes.

17. The system of claim 16, wherein the recovery subsystem imports patch data prior to completion of code modification.

18. A computer-implemented method for managing software patches, comprising:
receiving patch data from a plurality of heterogeneous patch data sources;
normalizing the patch data into a unified schema;
scanning one or more computing systems to detect missing patches using one or more detection rules;
generating installation instructions for the missing patches;
validating the installation instructions in an isolated execution environment;
deploying the patches to the one or more computing systems;
verifying installation success using the one or more detection rules;
updating a patch knowledge repository based on results of the deploying and verifying; and
performing a closed-loop process that improves subsequent patch deployments.

19. The method of claim 18, wherein the detection rules used to identify missing patches are reused to verify installation success without transformation.

20. The method of claim 19, wherein reuse of the detection rules eliminates a need for separate verification rule configuration.

21. A system for maintaining a patch repository, comprising:
a plurality of source adapters configured to retrieve patch data from external patch data sources;
a monitoring subsystem configured to detect failures in the source adapters, including:
explicit failures, and
silent failures in which a source adapter returns no patch data despite successful execution; and
a recovery subsystem configured, in response to detecting a failure, to:retrieve patch data directly from a corresponding external data source and update the patch repository; and
generate a modified version of the source adapter configured to correct the failure,wherein retrieving the patch data and generating the modified version of the source adapter are performed concurrently such that the patch repository remains current while the source adapter is corrected.

22. A computer-implemented system for orchestrating patch management operations, comprising:
a plurality of software agents executed by one or more processors, the agents comprising:
a triage agent configured to prioritize patches;
a conflict detection agent configured to identify incompatibilities between patches;
a sequencing agent configured to determine an installation order; and
a verification agent configured to evaluate results of patch installation;
a shared data structure configured to store outputs generated by the plurality of software agents; and
a processing pipeline configured to provide outputs of one software agent as inputs to another software agent;
wherein the system is further configured to:
detect a failure or inconsistency in a patch management operation;
modify one or more inputs, parameters, or instructions associated with the operation; and
re-execute at least a portion of the processing pipeline using the modified inputs until a defined success condition is satisfied.
